(19) United States
(12) Patent Application Publication
(10) Pub. No.: US 2023/0417129 A1
(43) Pub. Date: Dec. 28, 2023

(54) IN-SITU OIL UPGRADING VIA DEASPHALTING

(71) Applicant: Cenovus Energy Inc., Calgary (CA)

(72) Inventors: Amos BEN-ZVI, Calgary (CA); Nashaat NASSAR, Calgary (CA); Paulina MORASSE, Calgary (CA); Lukemon ADETUNJI, Calgary (CA)

(21) Appl. No.: 18/338,244

(22) Filed: Jun. 20, 2023

Related U.S. Application Data
(60) Provisional application No. 63/355,357, filed on Jun. 24, 2022.

(51) Int. Cl. E21B 43/24; E21B 43/38; C09K 8/524; C09K 8/592; C09K 8/594

(52) U.S. Cl. CPC E21B 43/2408; E21B 43/38; C09K 8/524; C09K 8/592; C09K 8/594

(57) ABSTRACT

A method for producing hydrocarbons from a subterranean reservoir, the method comprising the steps of: injecting steam and injecting a silica-based asphaltene-sorbent into the subterranean reservoir; allowing the silica-based asphaltene-sorbent to adsorb asphaltenes from the hydrocarbons, thereby producing upgraded hydrocarbons and asphaltenes adsorbed to the silica-based asphaltene-sorbent in the subterranean reservoir; and producing the upgraded hydrocarbons, without producing the asphaltenes adsorbed to the silica-based asphaltene-sorbent.

### CROSS-REFERENCE TO RELATED APPLICATION(S)

This application claims the benefit of U.S. Provisional Application No. 63/355,357 entitled “IN-SITU OIL UPGRADING VIA DEASPHALTING” and filed on Jun. 24, 2022, which is expressly incorporated by reference herein in its entirety.

### FIELD OF THE INVENTION

The present invention relates to production of hydrocarbons from a subterranean reservoir using steam injection to enhance production, such as in a SAGD well system, and more particularly to use of a particle, which may be a nanoparticle, to adsorb asphaltenes in the subterranean reservoir to upgrade the hydrocarbons in-situ in the subterranean reservoir.

### BACKGROUND OF THE INVENTION

In-Situ Hydrocarbon Production.

Hydrocarbons can be produced from a subterranean reservoir by hot water or steam (collectively referred to as steam) injection to the reservoir. This is called in-situ production. In general, steam injection is a technique for enhancing production of hydrocarbons from a subterranean reservoir to the surface by injecting steam into a reservoir to reduce the viscosity of hydrocarbons in the reservoir, so that the hydrocarbons flow more readily to a producing well.

Steam assisted gravity drainage (SAGD) is an example of steam injection that involves injecting steam from the surface into an upper horizontal well (an injection well) disposed in the reservoir above a lower horizontal well (a production well). The injected steam exits the injection well and rises in the reservoir to form a steam-saturated zone, which is conceptualized as a “steam chamber”, where hydrocarbons are heated by the steam and thereby reduced in viscosity. The reduced-viscosity hydrocarbons drain downward by gravity into the production well, and are produced to the surface.

Asphaltenes in Produced Hydrocarbons.

Hydrocarbons produced by steam injection may be heavy oils. Generally, heavy oil has a high asphaltene content. Asphaltenes are complex polar aromatic and high macromolecules. Generally, asphaltenes are defined as the n-heptane insoluble and benzene/toluene soluble fraction of crude oil including heavy oil.

Asphaltenes create problems during production and handling of heavy oil. The viscosity of heavy oil is quite high and equipment fouling can occur due to the presence of asphaltenes in the oil.

Generally, upgrading is required to remove the asphaltenes. If heavy oil could be reliably upgraded in-situ, before being produced to surface, this would offer a significant benefit to producers.

### SUMMARY OF THE INVENTION

In one aspect, the present invention comprises a method for producing hydrocarbons from a subterranean reservoir.

In particular, a broad aspect of the invention is directed to a method for producing hydrocarbons from a subterranean reservoir, the method comprising the steps of: injecting steam and injecting a silica-based asphaltene-sorbent into the subterranean reservoir; allowing the silica-based asphaltene-sorbent to adsorb asphaltenes from the hydrocarbons, thereby producing upgraded hydrocarbons and asphaltenes adsorbed to the silica-based asphaltene-sorbent in the subterranean reservoir; and producing the upgraded hydrocarbons, without producing the asphaltenes adsorbed to the silica-based asphaltene-sorbent.

### BRIEF DESCRIPTION OF THE DRAWINGS

In the drawings, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 is a flow chart of a first embodiment of a method of the present invention, for production of hydrocarbons from a subterranean reservoir using a steam assisted gravity drainage (SAGD) well system, and using asphaltene-sorbent particles to adsorb asphaltene in the subterranean reservoir.

FIG. 2 is a schematic depiction of a SAGD well system that may be used in implementing the method of FIG. 1, along with asphaltene-sorbent particles attached to the subterranean reservoir.

FIGS. 3A to 3F are schematic depictions of sequential stages of the method of FIG. 1.

FIG. 3A shows a subterranean reservoir in relation to an injection tubing and production tubing of a SAGD well system.

FIG. 3B shows injection of a carrier fluid mixed with asphaltene-sorbent particles into the subterranean reservoir via the production tubing.

FIG. 3C shows injection of steam mixed with asphaltene-sorbent particles into the subterranean reservoir via the injection tubing.

FIG. 3D shows asphaltene-sorbent particles attached to sand in the subterranean reservoir, and adsorbing asphaltene molecules in the subterranean reservoir.

FIG. 3E shows hydrocarbons draining by gravity into the production tubing, while the asphaltene-sorbent particles with adsorbed asphaltene remain attached to the subterranean reservoir.

FIG. 3F shows production of hydrocarbons to the surface via the production tubing string.

FIG. 4 is a schematic representation of the 1-D sand bed SAGD setup for the experiments.

FIG. 5 is a chart showing recovery performance from nanoparticles and steam co-injection into an oil sand packed bed at the temperature of 230° C.

FIG. 6 is a chart showing the C₇-asphaltene content in the produced oil in the presence of nanoparticles.

### DETAILED DESCRIPTION OF EMBODIMENTS OF THE INVENTION

### Definitions

The present invention relates to production of hydrocarbons from a subterranean reservoir using a hot water or steam, collectively referred to as steam, injection operation with in-situ upgrading of the produced hydrocarbons using silica (SiO₂) as an asphaltene-sorbent particulate.

Any term or expression not expressly defined herein shall have its commonly accepted definition understood by a person skilled in the art. As used herein, the following terms have the following meanings.

“Subterranean reservoir” refers to a subsurface body of rock having porosity and permeability that is sufficient to permit storage and transmission of a liquid or gaseous fluid.

“Steam chamber”, in the context of a SAGD well system, refers to a region a subterranean reservoir that is in fluid and pressure communication with an injection well and that is subject to depletion of hydrocarbons, by gravity drainage, into a production well that is disposed parallel and below the injection well.

“Steam injection operation” refers to any method of producing hydrocarbons from a subterranean reservoir that involves injection of heated water, usually in the steam phase, into the subterranean reservoir to decrease the viscosity of the hydrocarbons, so that the hydrocarbons flow more easily in the subterranean reservoir. Without limitation, steam injection operations include methods known in the art as steam assisted gravity drainage (SAGD), steam flooding or steam drive, and cyclic steam stimulation (CSS).

“Hydrocarbons” refer to hydrocarbon substances naturally occurring in a subterranean reservoir. Hydrocarbons may be in liquid, gaseous, or solid phases. Without limitation, hydrocarbons may include “heavy oil”, referring to hydrocarbons having a mass density of greater than about 900 kg/m 3 under natural reservoir conditions. Without limitation, hydrocarbons and heavy oil may also include “bitumen” having a mass density of greater than about 1,000 kg/m 3 under natural reservoir conditions, and existing in semi-solid or solid phase under natural reservoir conditions. It will be understood that “hydrocarbon production”, “producing hydrocarbons” and like terms, as used herein, do not preclude co-production of non-hydrocarbon substances that may be mixed with hydrocarbons such as trace metals, and gases such as hydrogen sulfide that may be dissolved under natural reservoir conditions, but exist in a gaseous phase at surface conditions.

“Asphaltene” refers to the n-heptane insoluble and benzene/toluene soluble fraction of heavy oil. Asphaltenes are complex polar aromatic and high macromolecules.

“Asphaltene-sorbent particle” refers to a non-metal particle that has an affinity for asphaltene. In embodiments, this affinity may be based on principles of adsorption—i.e., the asphaltene-sorbent particle physically adheres and/or chemically bonds to asphaltene. In particular, the asphaltene-sorbent particle of interest is a non-metal, in the group called metalloids. In one embodiment, a useful asphaltene-sorbent particle includes silica (SiO₂). Silica is found to have an excellent affinity for asphaltene, is environmentally acceptable and abundant. In embodiments, the asphaltene-sorbent particle has a maximum dimension (e.g., a diameter) less than about 1000 nm, more particularly less than 500 nm, more particularly less than 250 nm. In embodiments, the asphaltene-sorbent particle is a “nanoparticle”, which as used herein, refers to a particle that has a maximum dimension less than 100 nm. In embodiments, a nanoparticle may have a maximum dimension less than 50 nm, and more particularly less than 25 nm.

Method.

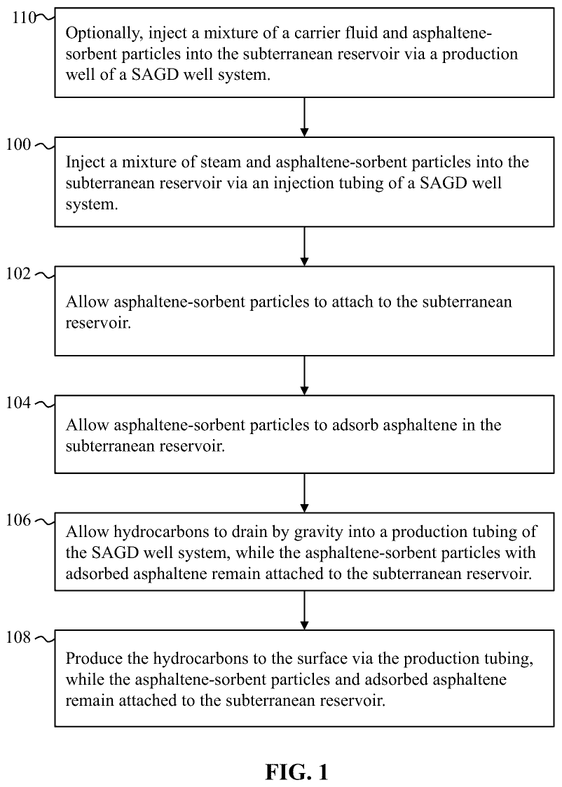

FIG. 1 is a flow chart of a first embodiment of a method of the present invention, for production of hydrocarbons from a subterranean reservoir using a steam assisted gravity drainage (SAGD) well system, and using asphaltene-sorbent particles to adsorb asphaltene in the subterranean reservoir. By adsorption of the asphaltene, the hydrocarbons become upgraded in the reservoir, before they are produced to surface. Adsorption of the asphaltene improves the viscosity of the hydrocarbons and simplifies handling.

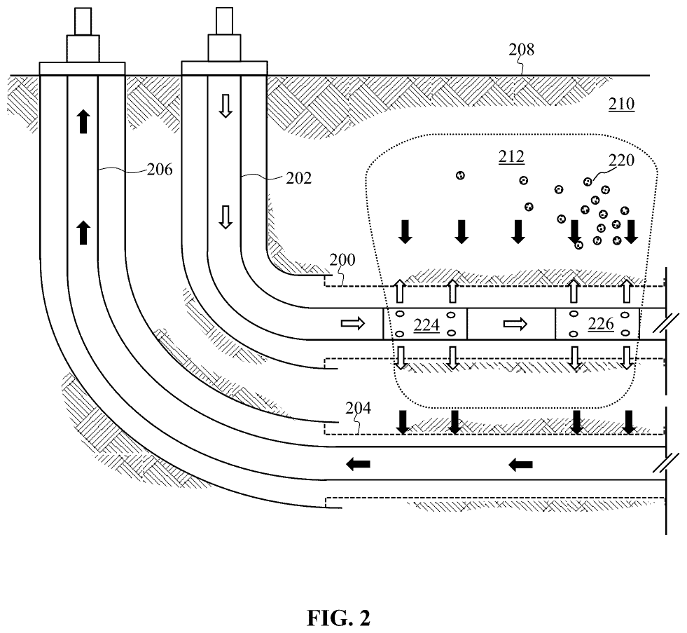

FIG. 2 is a schematic depiction of a SAGD well system that may be used in implementing the method of FIG. 1. SAGD well systems and their principle of operation are well known to persons skilled in the art. The following description is provided to facilitate understanding of the present invention. For simplicity of illustration, FIG. 2 omits various equipment items (e.g., steam generators, surface pumps, downhole pumps, sealing elements and so forth) that are commonly associated with a SAGD well system. The SAGD well system includes a horizontal or deviated (i.e. non-vertical) leg of an injection well 200 including an injection tubing 202, and a horizontal or deviated (i.e. non-vertical) leg of a production well 204 including a production tubing 206, extending from the surface 208 into a subterranean reservoir 210. The production well 204 is parallel to the injection well 200, and disposed below the injection well 200. A surface pump (not shown) is used to inject steam (as shown by hollow arrows) into the injection tubing 202, which exits via openings thereof, and through openings (e.g., a slotted liner) of the injection, well 200 into a subterranean reservoir to create a steam-saturated zone referred to as the steam chamber 212. In the steam chamber 212, the injected steam heats the hydrocarbons and thereby reduces their viscosity. The reduced-viscosity hydrocarbons (as shown by solid arrows) drain downward by gravity through openings (e.g., a slotted liner) of the production well 204, and into the production tubing 206. The hydrocarbons are produced to the surface via the production tubing 206.

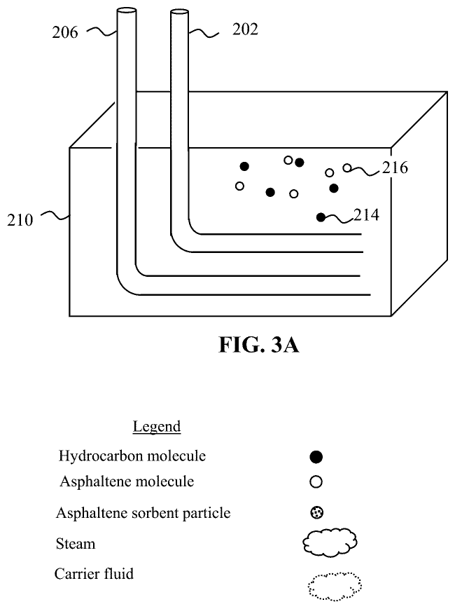

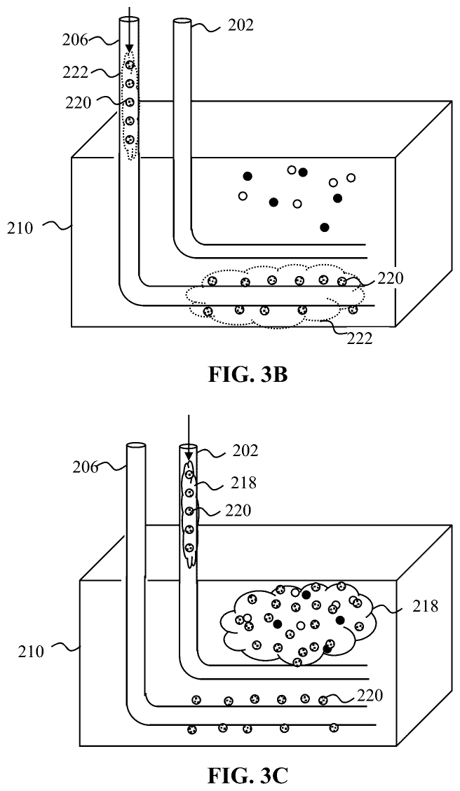

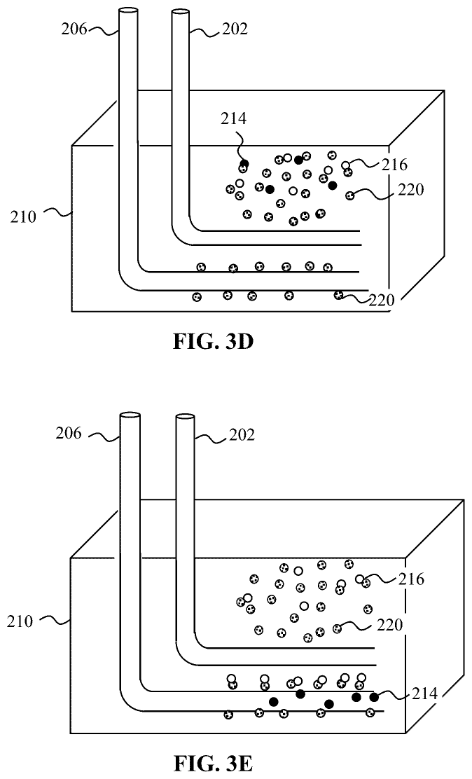

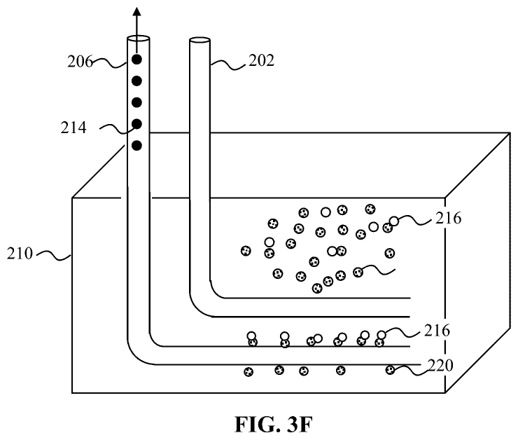

FIG. 3A is a schematic depiction of the injection tubing 202 and production tubing 206 of a SAGD well system in a subterranean reservoir 210 before steam injection. The subterranean reservoir contains hydrocarbons, as shown by hydrocarbon molecules 214, and asphaltene, as shown by asphaltene molecules 216.

Referring back to FIG. 1, at step 100, a mixture of steam and asphaltene-sorbent particles are injected, via the injection tubing string 202, into the subterranean reservoir. That is, asphaltene-sorbent particles are injected in the steam phase of the SAGD operation. Particles 220 are injected with, for example, as a mixture with or sequentially before or after, the steam of the SAGD operation. FIG. 3C is schematic depiction of step 100, showing steam 218 mixed with asphaltene-sorbent particles 220 being pumped into the subterranean reservoir 210. The asphaltene-sorbent particles 220 can be suspended in the injected steam 218 even at relatively low flow velocities of the injected steam, because of the small size of the asphaltene-sorbent particles.

In one embodiment, a carrier fluid may be employed for facilitated carrying of the particles. A useful carrier fluid is, for example, ethyl acetate.

In one embodiment, the injected mixture is asphaltene-sorbent particles in steam without any solvents added thereto. While solvents have been used for some in-situ recovery operations, their use in this process is best minimized and avoided to address cost and environmental considerations.

A variety of asphaltene-sorbent particles may be used in the present invention to adsorb asphaltene in the subterranean reservoir. In one embodiment, the asphaltene-sorbent particles are based on silica (SiO₂). It will be evident that the asphaltene-sorbent particles have to have an affinity for asphaltenes either by physical adherence or by chemical bonding. In fact, silica has a high affinity for asphaltene at pressure and temperature conditions in the subterranean reservoir, and relatively little to no affinity for valuable, non-asphaltene hydrocarbons in the subterranean reservoir under those conditions.

The selected asphaltene-sorbent particles may be capable of adsorbing asphaltene over the full range of temperatures expected to be encountered in the steam chamber of a SAGD well system, which typically ranges from about 15° C. to about 300° C. In particular embodiments, the asphaltene-sorbent particles may have high affinity for asphaltene at temperatures of about 110° C. or greater, more particularly of about 200° C. or greater, and even more particularly, of about 230° C. or greater, to about 300° C. In total, silica is effective for asphaltene removal at a range of temperatures including up to 300° C.

The asphaltene-sorbent particles should be sized so that they can permeate through the pores of the subterranean reservoir, without substantially impairing transmission of a liquid or gaseous fluid through the subterranean reservoir. A suitable size of asphaltene-sorbent particles may be selected having regard to the characteristics of a particular subterranean reservoir. As a non-limiting example, for subterranean reservoirs containing heavy oil in Alberta, Canada, a suitable maximum dimension (e.g., diameter) of asphaltene-sorbent particles may be less than about 1,000 nm, more particularly less than about 500 nm, and even more particularly less than about 250 nm. In some embodiments, the asphaltene-sorbent particles may be nanoparticles—i.e., particles having a maximum dimension (e.g., diameter) less than about 100 nm, more particularly less than about 50 nm, and even more particularly less than about 25 nm.

Use of asphaltene-sorbent particles having higher surface area per mass may increase their efficacy in adsorption of the asphaltene. In embodiments, the asphaltene-sorbent particles are configured to have a surface area per mass in the range from about 1 to about 3,000 m²/g. In some embodiments, the surface area per mass may be greater than 50 m²/g, greater than about 100 m²/g, greater than about 250 m²/g, greater than about 500 m²/g, greater than about 750 m²/g, and greater than about 1,000 m²/g.

Having regard to the asphaltene affinity of the selected asphaltene-sorbent particles, the concentration of asphaltene-sorbent particles in the mixture introduced to the reservoir may be selected to be effective in adsorbing asphaltene present in concentrations in the hydrocarbons in the subterranean reservoir, which typically range from about 20 ppm to about ppm and may range from 50 to 5,000 ppm. In one embodiment, the concentration of asphaltene-sorbent particles in the steam introduced to the formation is less than 397 ppm or less than 272 ppm or less than 136 ppm.

After injection of the asphaltene-sorbent particles, the particles adsorb asphaltene and the particles with asphaltene adsorbed thereto remain in the formation while the valuable, hydrocarbons are produced from the reservoir with a reduced asphaltene content over an untreated formation. While the invention is not intended to be bound by theory, it is believed that the asphaltene-sorbent particles become attached to the rock in the subterranean reservoir and the asphaltene adsorbs to the particles.

Therefore, for the purposes of illustration, in FIG. 1, at step 102, the asphaltene-sorbent particles that were injected into the subterranean reservoir in step 100, are allowed to soak. While it is not intended that the invention be limited by theory, it is believed that the particles attach to the subterranean reservoir during the soak phase. This step may be performed without any active intervention, by allowing for contact time between the injected mixture and the reservoir. Relatively quiescent conditions may facilitate the binding of the particles in the subterranean reservoir. For example, injection of the steam may be ceased to leave the asphaltene-sorbent particles in the subterranean reservoir for a period of time relatively undisturbed. The asphaltene-sorbent particles adhere to rock, such as sand particles, in the subterranean reservoir. Allowing the mixture to soak, relatively undisturbed in the reservoir facilitates this adhesion. FIG. 3D is a schematic depiction of step 102, showing the asphaltene-sorbent particles 220 attached to sand particles of the subterranean reservoir 200 after cessation of steam injection.

It is not an outright requirement to cease steam injection. However, cessation of steam injection may speed up the process of the asphaltene-sorbent particles contacting hydrocarbons in-situ and adsorbing asphaltenes from the hydrocarbons. Steam injection does not need to be ceased forever in this case, just stopped for a period of time.

In FIG. 1, at step 104, the asphaltene-sorbent particles are allowed to adsorb asphaltene in the subterranean reservoir. This step may be performed without any active intervention, by allowing for relatively quiescent conditions in the subterranean reservoir. FIG. 3D is a schematic depiction of this step showing the asphaltene-sorbent particles 220 attached to sand particles of the subterranean reservoir 200 and the adsorbed asphaltene molecules 216. While steps 102 and 104 are shown separately, there is no intervention that separates the two steps and they are effectively achieved by the same process of soaking.

In FIG. 1, at step 106, the hydrocarbons are allowed to drain by gravity into the production tubing string, while the asphaltene-sorbent particles with adsorbed asphaltene remain retained in, for example attached to, the subterranean reservoir. FIG. 3E is a schematic depiction of this step showing upgraded hydrocarbon molecules 214 within the production tubing 206 while the asphaltene-sorbent particles 220 with adsorbed asphaltene molecules 216 remain in the region of the steam chamber. The hydrocarbon molecules 214 are upgraded, since they contain less asphaltene than what would be produced without the addition of the asphaltene-sorbent particles.

In FIG. 1, at step 108, the upgraded hydrocarbons are produced to the surface via the production tubing. FIG. 3F is a schematic depiction of this step showing the upgraded hydrocarbon molecules 214 flowing to the surface via the production tubing 206.

As known to persons skilled in the art, SAGD (and other steam injection operations as described below) may be performed over many years with multiple cycles of a steam injection phase followed by a hydrocarbon production phase. Accordingly, steps 100 to 108 may be performed repeatedly in cycles, with each performance of step 100 corresponding to a steam injection phase of a cycle, and each performance of step 108 corresponding to a hydrocarbon production phase of the cycle. In particular, the amount or concentration of asphaltene-sorbent particles in the mixture that is injected into the subterranean reservoir at each cycle may be selectively varied, possibly to account for factors such as the amount or concentration of asphaltene-sorbent particles that have been previously injected in past cycles, or will be injected in subsequent cycles. This can be used to achieve a variety of advantageous effects. As one example, the concentration or amount of asphaltene-sorbent particles that is injected in any given cycle can be limited, with a view to incrementally increasing the concentration or amount of asphaltene-sorbent particles attached to the subterranean reservoir over multiple cycles. As another example, the concentration or amount of asphaltene-sorbent particles that is injected in any given cycle can be selected to control the distribution of asphaltene-sorbent particles in the subterranean reservoir. For instance, the volumetric portion of the subterranean reservoir that is “seeded” with the asphaltene-sorbent particles can be incrementally increased over multiple cycles. As still another example, the concentration or amount of asphaltene-sorbent particles in the mixture that is injected in any given cycle can be varied over cycles to account for varying levels of asphaltene concentration in produced fluids during the operation of the well, or to selectively vary the asphaltene concentration of fluids produced to the surface during the operation of the well.

Referring back to FIG. 1, the method may also include an optional step 110 that is applicable to steam injection operations, such as SAGD or steam flooding that use two wells, where one of the wells is an injection well for injection of steam, and the other well is a production well for production of hydrocarbons to the surface. At step 110, a mixture of a carrier fluid and additional asphaltene-sorbent particles are injected via the production tubing string 206 of the production well 204 into the subterranean reservoir. That is, the production tubing string 206 is used in a non-conventional manner to convey material from the surface into the subterranean reservoir. FIG. 3B is a schematic depiction of step 110, showing the carrier fluid 222 mixed with additional asphaltene-sorbent particles 220 being pumped into the subterranean reservoir. In embodiments, the carrier fluid 222 may be a liquid such as water or ethyl acetate. In embodiments, the carrier fluid 222 may be a gas, such as a nitrogen or methane. The carrier fluid may be transported to the well head of the production well such as by truck or other means. In like manner as the asphaltene-sorbent particles that are injected at step 100, the additional asphaltene-sorbent particles that are injected in step 110 will prevent asphaltene from being produced and cause the asphaltene contacted by the carrier fluid/particle mixture to be retained in the subterranean reservoir. FIG. 1, and the sequence of FIGS. 3A to 3F, show step 110 as being performed prior to steps 100 to 108. However, it will be understood that step 110 may be performed periodically, and in other orders relative to these steps, but preferably in such an order that does not interfere with migration of hydrocarbons to the production well, and production of hydrocarbons to the surface via the production well. Further, by use of flow control devices associated with the production well, the carrier fluid and additional asphaltene-sorbent particles may be injected into those portions of the subterranean reservoir surrounding the production well where hydrocarbons are most likely to be produced. Such locations may be predicted by persons skilled in the art, and/or determined empirically when the well system is in operation.

Controlled Placement of Asphaltene-Sorbent Particles.

The contact time between the hydrocarbons and the asphaltene-sorbent particles in the subterranean reservoir may be quite brief due to flow of steam through the formation. As such, creating regions of the subterranean reservoir that have higher concentrations of steam containing asphaltene-sorbent particles, and controlling the flow of the steam/particulate mixture through such regions may promote contact of the asphaltene-sorbent particles with the hydrocarbons and the asphaltene therein, and therefore make the most economical and effective use of the asphaltene-sorbent particles.

As a non-limiting example, referring back to the FIG. 2, the injection tubing 202 may include a plurality of steam flow control devices, including a first steam flow control device 224 and a second steam flow control device 226, disposed at different positions along the subterranean reservoir. “Steam flow control device”, as used herein, refers to any mechanical device that can be incorporated into a downhole string, and actuated to selectively control flow of steam out of the downhole tubing and into the surrounding wellbore. Steam flow control devices are known to persons skilled in the art. Steam flow control devices may be referred to in the art as “steam splitters”, “steam diverter”, “steam valves”, “steam injection mandrels”, and like terms. As a non-limiting example, a steam flow control device may comprise a body defining a bore, and a sleeve or other valve member that is movable relative to the body between alternate positions that either block or allow steam to flow out of openings defined by the bore. Movement of the sleeve or valve member may be actuated by means such as shift tools, balls, pressure differentials, or other mechanisms as known to persons skilled in the art.

By control of the steam flow control devices (and the use of possible sealing elements associated with the injection tubing 202, such as sealing elements used for zonal isolation), it is possible to establish pressure gradients of the steam mixed with asphaltene-sorbent particles 220 that are injected into the subterranean reservoir in step 100. These pressure gradients will affect the distribution of asphaltene-sorbent particles 220, as the injected steam and asphaltene-sorbent particles 220 will tend to migrate from regions of higher pressure to regions of lower pressure. In FIG. 2, for example, closing of the first steam flow control device 224 and opening of the second steam flow control device 226 may create a region of relatively lower pressure in the vicinity of the first steam flow control device 224, and a region of relatively higher pressure in the vicinity of the second steam flow control device 226. Accordingly, asphaltene-sorbent particles 220 injected into the subterranean formation via the second steam flow control device 226 may tend to flow from right to left in the drawing plane of FIG. 2. This may result in a region having a higher concentration of asphaltene-sorbent particles 220 near the second steam flow control device 226, as compared with the region near the first steam flow control device 224. (The asphaltene-sorbent particles 220 would be expected to become more diffuse in concentration with increased distance from their injection location at the second steam flow control device 226.)

Pressure gradients also tend to cause steam in the steam chamber 212 to flow from regions of relatively high pressure to regions of relatively low pressure. Accordingly, the steam flow control devices or other means may also be selectively controlled to establish a pressure gradient that affects the flow of steam in the steam chamber 212 to regions of the steam chamber 212 having relatively higher concentrations of asphaltene-sorbent particles 220. For example, after the asphaltene-sorbent particles 220 are allowed to attach the sand particles of the subterranean reservoir, injection of steam (without further injection asphaltene-sorbent particles 220) into the steam chamber 212 may be continued. Opening of the first steam flow control device 224 and closing of the second steam flow control device 226 may create a region of relatively higher pressure in the vicinity of the first steam flow control device 224, as compared with the region in the vicinity of the second steam flow control device 226. Accordingly, steam will tend to flow from left to right in the drawing plane of FIG. 2, so as to flow through the region of the steam chamber 212 in the vicinity of the second steam flow control device 226 having the relatively higher concentration of asphaltene-sorbent particles 220, preferentially over other regions having relatively lower concentrations of asphaltene-sorbent particles 220.

Adaption to Other Well Systems and Steam Injection Operations.

In the embodiment of FIGS. 3A to 3F, the method is implemented using a SAGD well system. In other embodiments, the method may be implemented for other steam injection operations, including cyclic steam stimulation (CSS), steam flooding or steam drive.

As known in the art, cyclic steam stimulation typically involves a “steam phase” of injecting steam into the reservoir via the well, a “soak phase” of allowing the steam to soak into the reservoir near the well and thereby reduce viscosity of hydrocarbons, and a “production phase” of producing hydrocarbons to the surface from the same well. The method of the present invention may be implemented by: (i) injecting steam and asphaltene-sorbent particles into the subterranean reservoir via the well during the “steam phase”. This may include injecting a mixture of steam and particles, mixed at surface or sequential injections of steam and then particles in various orders. The particles may be in a carrier fluid. Then, (ii) allowing a “soak phase” where the particles adsorb asphaltene in the subterranean reservoir; and (iii) producing the hydrocarbons to the surface via the same well during the “production phase”, without producing the asphaltene-sorbent particles with adsorbed asphaltene that remain attached to the subterranean reservoir. Thus, it will be understood that the method may be implemented using a single well system, which may be a vertical well.

As known in the art, steam flooding or steam drive typically involves injecting steam into a reservoir via a first well to reduce the viscosity of hydrocarbons and displace the hydrocarbons toward a different second well. In contrast to SAGD, the first well and the second well may both be vertical wells that are horizontally spaced apart from each other. The method of the present invention may be implemented by: injecting a mixture of steam and asphaltene-sorbent particles into the subterranean reservoir via the first well; allowing asphaltene-sorbent particles to attach to the subterranean reservoir that is disposed horizontally between the first and second wells, and adsorb asphaltene in that subterranean reservoir; and producing the hydrocarbons to the surface via the second well, without producing the asphaltene-sorbent particles with adsorbed asphaltene that are retained in the subterranean reservoir. Thus, it will be understood that the method may be implemented using steam flooding or steam drive.

### Examples

Materials

Heavy crude oil from applicant's resources that was used in these examples has 9.2°+0.1 API (with a specific gravity of 1.0056 at 15.6° C.), the viscosity of 78,750 cP at 25° C., and an approximate content of 10.3 wt % of asphaltenes. The nanoparticles employed herein is fumed silica (SiO₂). The nanoparticles were in powder form with each particle having a maximum dimension of less than 100 nm.

Adsorption of Asphaltenes

Asphaltenes were extracted from the heavy crude oil. A heavy oil model solution was prepare where extracted asphaltenes were dissolved in toluene.

Adsorption experiments were conducted by adding 100 mg of nanoparticle in 10 mL of the prepared heavy oil model solution at 25° C. The mixture was mixed under the orbital shaker and allowed to equilibrate for 24 h. The mixtures were left for 30 minutes and nanoparticles with adsorbed asphaltene settled out.

1-D Physical Model of Sand Packed Bed for Simulating SAGD Conditions

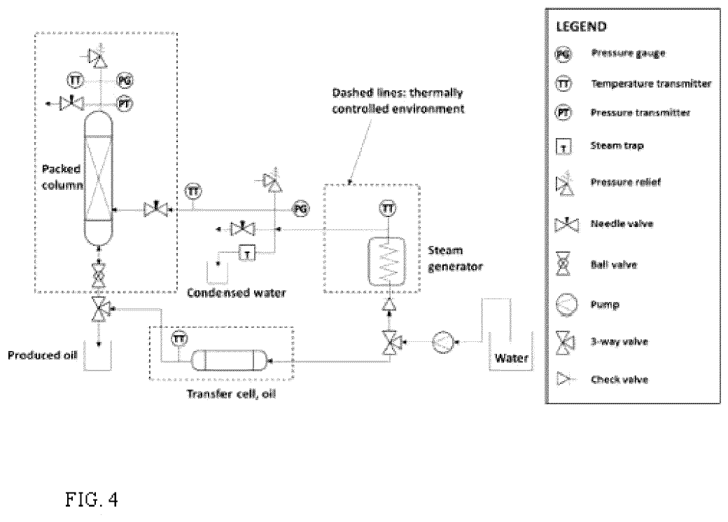

The model SAGD set up is designed as shown in FIG. 4. Each run starts with packing the sand in the column, then saturate the reactor with bitumen oil using the pump connected to the accumulator. After that, a steam generator provides steam up to 230° C. through the coiled tubes, steam is saturated within the reactor for different time intervals, and the system is left to soak for also different time intervals. The nanoparticles are injected in the form of nanofluid upon injecting the steam. The asphaltene content and viscosity of the oil produced by saturating steam in a sand packed column with and without nanoparticles are compared to determine the role of nanoparticles in reducing asphaltenes precipitation or aggregation insitu.

SAGD Displacement Experiment

In this part of the study, a 1-D sand pack model based on the experimental setup presented previously in FIG. 4 was used to run the SAGD experiments. The dimensions of the sand pack were 2.2098 cm (D) by 22.42 cm (L). The provided sand was washed and sieved to mesh size 80 then packed to the column. The pore volume was estimated from the mass and density of the sand. To minimize heat loses, the model was wrapped with heating tapes and aluminum foil then distributed with thermocouples to capture the temperature of the entire model. Bitumen in the transfer cell was heated up to 100° C. to make it movable and it was saturated to the model using the Isco pump. After saturation, the reactor was set for steam injection with and without nanoparticles in the coil. For the SAGD experiment, steam was injected at a rate of 3.5 mL/min cold water equivalent (CWE) and the experiment lasted for 2 h. For the experiment with silica nanoparticles, the nanofluids have been formulated using deionized water. The concentration of nanoparticles was estimated based on the mass of nanoparticles over the volume of total steam injected. The produced bitumen/water emulsion was separated by gravity and the retained bitumen samples have been analyzed for viscosity, API and asphaltene content.

Oil Recovery

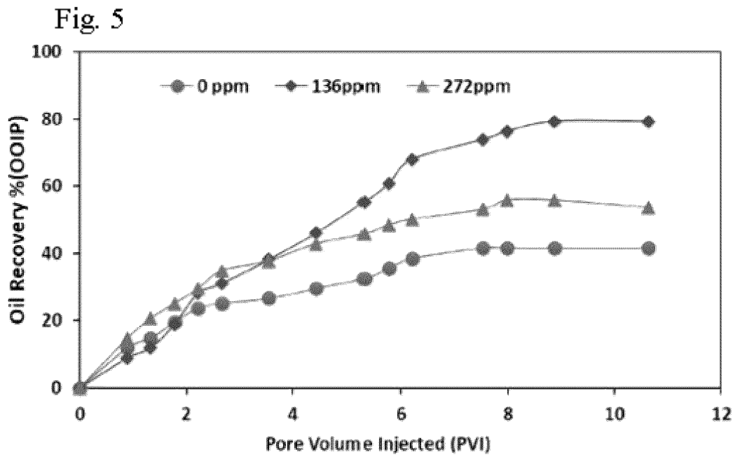

FIG. 5 shows the bitumen recovery as a function of pore volume injection (PVI). As seen, recovery of bitumen increased with PVI injection and continues until the end of the experiments. It can be interpreted that the presence of nanoparticles inside the medium caused the production of lighter components via in-situ adsorption and trapping of asphaltene. A higher concentration of nanoparticles might cause aggregation and blockage in porous media.

Tracing Nanoparticles Inside the Reactor

Cryo-SEM experiments were performed to confirm the presence of the injected nanoparticles inside the reactor. Samples were frozen in nitrogen slush, and then vacuum transferred to the sample preparation chamber (Gatan ALTO2500). In the prep chamber, the samples were held at a temperature of −150° C. and fractured under vacuum. Samples were transferred into the evacuated SEM sample chamber via a vacuum transfer tube. Imaging was performed using 10 keV electrons under low vacuum conditions at a pressure of 30 Pa using dry nitrogen.

ESEM microphotographs of two selected samples from the top (entrance of injection point) and the middle of the reaction zone were reviewed. A higher population of deposited particles appeared at the top of reaction zone compared to the middle zone. Despite the aggregation of particles at the entrance of the reaction zone still, nanoparticles did propagate through the sand packed bed column and smaller particles were observed at the middle of the reaction zone.

Asphaltene Analysis Using C7

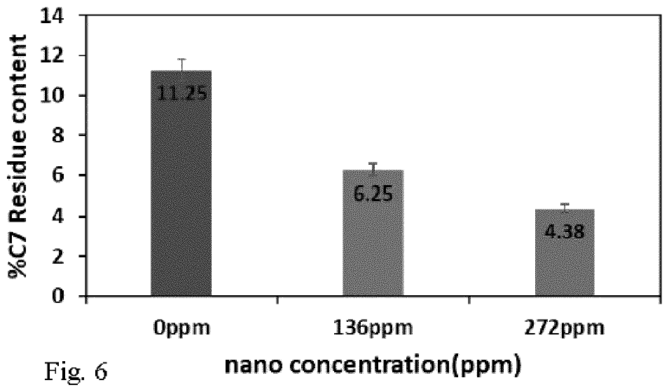

The asphaltene content in the produced oil was estimated and the obtained solid (asphaltene) estimations are summarized in FIG. 6.

We can see from the FIG. 6 that the asphaltene content in the produced oil reduced from 11.3% from the original oil sample with 0 ppm nanoparticle injection to 6.3% and 4.4% with 136 ppm and 272 ppm nanoparticle, respectively. This indicates that asphaltene adsorption is occurring in-situ during the SAGD experiment in the presence of nanoparticles and is correlated with nanoparticle concentration as the asphaltene content is decreasing in the produced oil as the concentration of nanoparticles increases.

Analysis of C5-Asphaltenes

Experiments were performed again using a concentration of 136 ppm nanoparticles but using C₅-asphaltenes instead of C₇-asphaltenes. The nanofluid was formulated by dispersing the selected mass fractions of nanoparticles to distilled water. These concentrations have been computed based on the mass of steam injected in the system. For the effect of time, steam was injected for 2 h, and early in the steam injection, 10 mL of nanofluid was injected. The total volume of steam injected for the 2 h was equivalent to 10.6 PV where 1 PV is equivalent 33.8 mL of steam. This implies that a total volume of steam injected is equivalent to 358.28 mL in the 2 h of oil production for the 10 mL nanofluid injection. Two samples were evaluated at two different time intervals to compare the % residual of asphaltene and resins produced as a function of time for the two hours of steam injection. Sample 1 was obtained after the first 1 h after injection of 10 mL nanofluid, while Sample 2 was obtained after 2 h for the same nanofluid; without injection of any additional nanofluids.

The extracted residual was on average 15.6% for the 2 cycles of nanofluid injection in 2 h for 0 ppm of nanoparticles. For the nanoparticle injection a first one hour of steam and 132 ppm nanoparticles, residual content at the end of 1 h dropped to 12.5%. After the second hour, the concentration of nanoparticles in the system reduced to 68 ppm due to more steam injection. The residual content after the second hour did not show any significant change, which is expected due to the decrease of the nano concentration in the system as more steam is injected into the system.

While higher concentrations of initial nanoparticle injections were employed in reruns of this test, the residual results did not improve significantly.

Effect of Cycle Injection

Effect of nanofluid cycle injection was evaluated by injecting a pulse of 10 mL after each 1 hour for a total of 2 h and the C₅-asphaltene content in the two samples was evaluated. The nanofluid was formulated by dispersing the selected mass fractions of nanoparticles to distilled water to formulate nanofluid ranging from 66 ppm to 397 ppm. These concentrations are fractions of the total steam injected for each cycle, respectively. For the effect of the first injection cycle, aliquots of 10 mL nanofluid were injected during the steam injection. The total volume of steam injected for the 1 h was still equivalent to 5.3 PV where 1 PV is equivalent 33.8 mL of steam; this implies that a total volume of steam injected at the end of the first cycle is equivalent to 179.14 mL in the 1 h of oil.

It was determined that injecting the same nanofluid concentration but at different cycles resulted in a noticeable asphaltene reduction; the first cycle an injection of 132 ppm after 1 h resulted in 13.8% and after the second cycle with the injection of additional 10 mL nanofluid (66 ppm) in the system, the content dropped to 10.6%. A similar trend was observed with the injection of 264 ppm and 397 ppm, respectively as a fraction of the total steam injected. For the first cycle injection of 264 ppm: after 1 h residual content was 13.1% and after the second cycle with the injection of additional 10 mL nanofluid (132 ppm), the residual content dropped to 11%. For the first cycle injection of 397 ppm: after 1 h residual content was 17.5% and after the second cycle with the injection of additional 10 mL nanofluid (199 ppm), the residual content dropped to 13.5%.

Although the effect of increasing the concentration as explained previously had no significant effect on the asphaltene and resin reduction, with the injection of more nanofluid during the second cycle there was a noticeable residual reduction from the produced oil. It is believed that the injection of addition nanofluid after the first cycle, provides more nanoparticles to interact again with the oil in the system and more in-situ adsorption of the residual may take place with more steam injection that results in an additional oil upgrade.

Interpretation.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

The claimed invention is:

1. A method for producing hydrocarbons from a subterranean reservoir, the method comprising the steps of:
(a) injecting steam and injecting a silica-based asphaltene-sorbent into the subterranean reservoir;
(b) allowing the silica-based asphaltene-sorbent to adsorb asphaltenes from the hydrocarbons, thereby producing upgraded hydrocarbons and asphaltenes adsorbed to the silica-based asphaltene-sorbent in the subterranean reservoir; and
(c) producing the upgraded hydrocarbons, without producing the asphaltenes adsorbed to the silica-based asphaltene-sorbent.

2. The method of claim 1, wherein the silica-based asphaltene-sorbent is a particulate comprising nanoparticles.

3. The method of claim 1, wherein the silica-based asphaltene-sorbent is silica.

4. The method of claim 1, wherein steps according to steps (a) and (b) are performed in a first cycle, and then steps (a) to (c) are repeated in a second cycle.

5. The method of claim 4, wherein step (a) of the first cycle injects a first concentration of the silica-based asphaltene-sorbent into the subterranean formation, and step (a) of the second cycle injects a second concentration of the silica-based asphaltene-sorbent into the subterranean formation, wherein the second concentration is different from the concentration.

6. The method of claim 1, wherein step (a) injects the steam and the silica-based asphaltene-sorbent as a mixture.

7. The method of claim 1, wherein step (a) injects the steam first and the silica-based asphaltene-sorbent sequentially.

8. The method of claim 1, wherein step (a) injects the silica-based asphaltene-sorbent in a carrier fluid.

9. The method of claim 8, wherein the carrier fluid is ethyl acetate, water and/or hydrocarbon.

10. The method of claim 8, wherein the carrier fluid is nitrogen and/or methane.

11. The method of claim 1, wherein steam injection is ceased during step (b).

12. The method of claim 1, wherein producing the upgraded hydrocarbons produces bitumen.

13. The method of claim 1, wherein producing the upgraded hydrocarbons produces heavy oil.

14. The method of claim 1, wherein injecting a silica-based asphaltene-sorbent includes operating flow control devices to select for different parts of the well and different times of injection.

15. The method of claim 1, wherein injecting a silica-based asphaltene-sorbent includes wherein the silica-based asphaltene-sorbent concentration is less than or equal to 397 ppm.

16. The method of claim 15, wherein injecting a silica-based asphaltene-sorbent includes wherein the silica-based asphaltene-sorbent concentration is less than or equal to 136 ppm.

17. The method of claim 1, wherein steps (a) and (b) are focused in a near wellbore region of a well.

18. The method of claim 1, wherein steps (a) to (c) are part of a SAGD operation.

19. The method of claim 18, wherein step (a) is conducted through a well adjacent to a SAGD injection well.

20. The method of claim 1, wherein the silica-based asphaltene-sorbent is a particulate configured to have a surface area per mass in the range from about 1 to about 3,000 m²/g.

21. The method of claim 1, where the subterranean reservoir has a temperature of 200 to 300 C.

22. The method of claim 1, where the subterranean reservoir has pressure of 500 kPa to 9 MPa.
